(19) United States
(12) Patent Application Publication
(10) Pub. No.: US 2005/0174919 A1
(43) Pub. Date: Aug. 11, 2005

(54) OPTICAL POLARIZATION CONTROLLER

(76) Inventors: Shih-Chieh Chang, Taipei County (TW); Chun-Lin Kuo, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/905,767

(22) Filed: Jan. 20, 2005

(30) Foreign Application Priority Data
Feb. 9, 2004 (TW) 93102896

(51) Int. Cl. G11B 7/00

(52) U.S. Cl. 369/112.16

(57) ABSTRACT

A optical polarization controller for receiving an input light beam and outputting a transverse magnetic (TM) polarized light beam or transverse electric (TE) polarized light beam is provided. The optical polarization controller includes a polarization splitting device and a half-wave plate. The polarization splitting device is provided for receiving the input light beam and outputting a first light beam and a second light beam. In addition, the half-wave plate is switchably disposed in the light path of the first light beam or the second light beam.

### CROSS-REFERENCE TO RELATED APPLICATION

This application claims the priority benefit of Taiwan application serial no. 93102896, filed Feb. 9, 2004.

### BACKGROUND OF THE INVENTION

1. Field of the Invention

The present invention generally relates to an optical polarization controller. More particularly, the present invention relates to an optical polarization controller for outputting a transverse electric (TE) polarized light beam or a transverse magnetic (TM) polarized light beam.

2. Description of Related Art

In recent years, since the application of internet has been widely developed, the enhancement of the bandwidth of internet is important and highly desirable. Therefore, how to in increase the data transmission under the limitation of existing bandwidth is an important issue. In general, as a signal transmission material, the optical fiber has the advantages of high communication capacity, low signal loss, non-electromagnetic interference, light-weight and small size in comparison with conventional twisted pair copper line. In the early days, only a single wavelength light beam may be used in the optical fiber for signal transmission. However, when the wavelength combination and wavelength division technology is developed, a light beam having a plurality of wavelengths and two polarization direction including transverse electric (TE) mode and transverse magnetic (TM) mode may be applied in an optical fiber for signal transmission. Therefore, the bandwidth of the optical fiber is increased. In order to achieve the wavelength combination and wavelength division technology described above, for example, dense wavelength division multiplexer (DWDM), wavelength division multiplexer (WDM), optical add/drop multiplexer (OADM), and polarization division Multiplexer (PDM) are developed.

In the optical fiber communication technology, since the planar waveguide and polarization division Multiplexer (PDM) are widely used, more and more light beam of input signal of device has to be polarized light beam. A polarized light beam may be formed by, for example, using polarization beam splitter (PBS) mirror or birefringent crystal to split a single wavelength light beam into transverse electric (TE) polarized light beam and transverse magnetic (TM) polarized light beam. Therefore, a transverse electric (TE) mode light beam, a transverse magnetic (TM) mode light beam may be provided. Then, the signal is carried by a TE polarized light beam or a TM polarized light beam. Thereafter, a dense wavelength division multiplexer (DWDM) or a wavelength division multiplexer (WDM) is provided to introduce the TE polarized light beam or the TM polarized light beam with a variety of wavelengths into the optical fiber.

It is noted that, in general, when a TE polarized light beam is used for carrying the data, the TM polarized light beam is abandoned. Therefore, the light intensity of the TE polarized or TM polarized light beam for data transmission is less than the light intensity of the original single wavelength light beam.

### SUMMARY OF THE INVENTION

Accordingly, the present invention provides an optical polarization controller for outputting a transverse electric (TE) or transverse magnetic (TM) polarized light beam, and the light intensity of the outputted polarized light beam is approximate to the light intensity of the inputted single wavelength light beam.

In addition, the present invention provides an optical polarization controller for outputting a transverse electric (TE) or transverse magnetic (TM) polarization light beam. Thus, the light intensity of the outputted polarized light beam is approximate to the light intensity of the inputted single wavelength light beam, and the polarization direction of the TE or TM polarized light beam of the optical polarization controller may be controlled.

In one embodiment of the present invention, an optical polarization controller for receiving an input light beam and outputting a TM polarized light beam or TE polarized light beam is provided. The optical polarization controller comprises, for example but not limited to, a polarization splitting device and a half-wave plate. The polarization splitting device is provided for receiving the input light beam and outputting a first light beam and a second light beam. The half-wave plate is switchably disposed in the light path of the first light beam or the second light beam.

In one embodiment of the present invention, the optical polarization controller further comprises, for example but not limited to, a phase compensating crystal disposed in the light path of the first light beam.

In one embodiment of the present invention, the polarization splitting device described above further comprises, for example but not limited to, a light incidence plane, a first exit plane of light beam and a second exit plane of light beam. In addition, the distance between the light incidence plane and the first exit plane of light beam is larger than the distance between the light incidence plane and the second exit plane of light beam. Thus, the first light beam and the second light beam have the same phase.

In one embodiment of the present invention, the optical polarization controller further comprises, for example but not limited to, a collimating device disposed in the light path of the first light beam and the second light beam after the half-wave plate. In addition, the optical polarization controller further comprises, for example but not limited to, a polarization maintaining optical fiber connected after the collimating device.

The present invention provides an optical polarization controller for receiving a light beam and outputting a TM polarized light beam or a TE polarized light beam. The optical polarization controller comprises, for example but not limited to, a polarization splitting device, a half-wave plate and a rotation mechanism. The polarization splitting device is provided for receiving the input light beam and outputting a first light beam and a second light beam. In addition, the half-wave plate is switchably disposed in the light path of the first light beam or the second light beam. Moreover, the rotation mechanism is provided for loading the polarization splitting device and the half-wave plate, wherein the rotation axis of the rotation mechanism is parallel to the propagation direction of the first light beam and the second light beam.

In one embodiment of the present invention, the optical polarization controller further comprises, for example but not limited to, a phase compensating crystal disposed on the rotation mechanism on and in the light path of the first light beam.

In one embodiment of the present invention, the polarization splitting device further comprises, for example but not limited to, a light incidence plane, a first exit plane of light beam and a second exit plane of light beam. In addition, the distance of the light incidence plane and the first exit plane of light beam is larger than the distance between the light incidence plane and the second exit plane of light beam. Thus, the first light beam and the second light beam have the same phase.

In one embodiment of the present invention, the optical polarization controller further comprises, for example but not limited to, a collimating device disposed in the light path of the first light beam and the second light beam after the half-wave plate. In addition, the optical polarization controller further comprises, for example but not limited to, a polarization maintaining optical fiber connected after the collimating device. Moreover, the optical polarization controller further comprises, for example but not limited to, a planar waveguide chip connected to the polarization maintaining optical fiber.

Accordingly, the optical polarization controller of the present invention outputs a TM or a TE polarized light beam by switching the position of the half-wave plate, and the light intensity of the outputted TM or TE polarized light beam are approximate to that of the input light beam. In addition, the optical polarization controller of the present invention provides a rotation mechanism to change the polarization direction of the outputted TM or TE polarized light beam.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The following drawings illustrate embodiments of the invention and, together with the description, serve to explain the principles of the invention.

FIG. 1 is a drawing schematically illustrating an optical polarization controller according to one embodiment of the present invention.

FIG. 2 is a drawing schematically illustrating an optical polarization controller according to one embodiment of the present invention.

FIG. 3 is a drawing schematically illustrating an optical polarization controller according to one embodiment of the present invention.

FIG. 4 is a drawing schematically illustrating an optical polarization controller according to one embodiment of the present invention.

FIG. 5 is a drawing schematically illustrating an optical polarization controller according to one embodiment of the present invention.

FIG. 6 is a drawing schematically illustrating an optical polarization controller according to one embodiment of the present invention.

FIG. 7 is a drawing schematically illustrating an optical add multiplexer (OADM) used for the optical polarization controller of the present invention.

### DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

FIG. 1 is a drawing schematically illustrating an optical polarization controller according to one embodiment of the present invention. Referring to FIG. 1, the optical polarization controller 200 is provided for receiving an input light beam 130 and outputting a transverse magnetic (TM) polarized light beam or a transverse electric (TE) polarized light beam. The polarization direction of the TM polarized light beam and that of the TE polarized light beam are mutually perpendicular. The input light beam 130 is provided by a collimator 120, and the collimator 120 is connected to an input optical fiber 110. The optical polarization controller 200 comprises, for example but not limited to, a polarization splitting device 210 and a half-wave plate 220. The polarization splitting device 210 is provided for receiving input light beam 130 and outputting a first light beam 212 and a second light beam 214. Moreover, the half-wave plate 220 is switchably disposed in the light path of the first light beam 212 or the second light beam 214.

Referring to FIG. 1, the input light beam 130 comprises, for example but not limited to, a single wavelength light beam such as a laser beam. The polarization splitting device 210 comprises, for example but not limited to, a polarization beam splitter (PBS) mirror, a birefringent crystal or a multiple quantum well waveguide. For example, if a TM polarized light beam has to be outputted, the input light beam 130 is inputted via the optical fiber 110 and transmitted to the collimator 120, and then incident to the polarization splitting device 210. After the input light beam 130 passes the polarization splitting device 210, the input light beam 130 is split into a first light beam (for example, a TM polarized light beam) 212 and a second light beam 214 (for example, a TE polarized light beam). At this moment, in order to output a TM polarized light beam, the half-wave plate 220 is switched to the light path of the second light beam 214. Therefore, after the second light beam 214 passes the half-wave plate 220, the second light beam 214 is transformed into a TM polarized light beam. It is noted that, when the optical polarization controller 200 has to output a TE polarized light beam, the half-wave plate 220 is switched to the light path of the first light beam 212. Therefore, a TE polarized light beam may be provided.

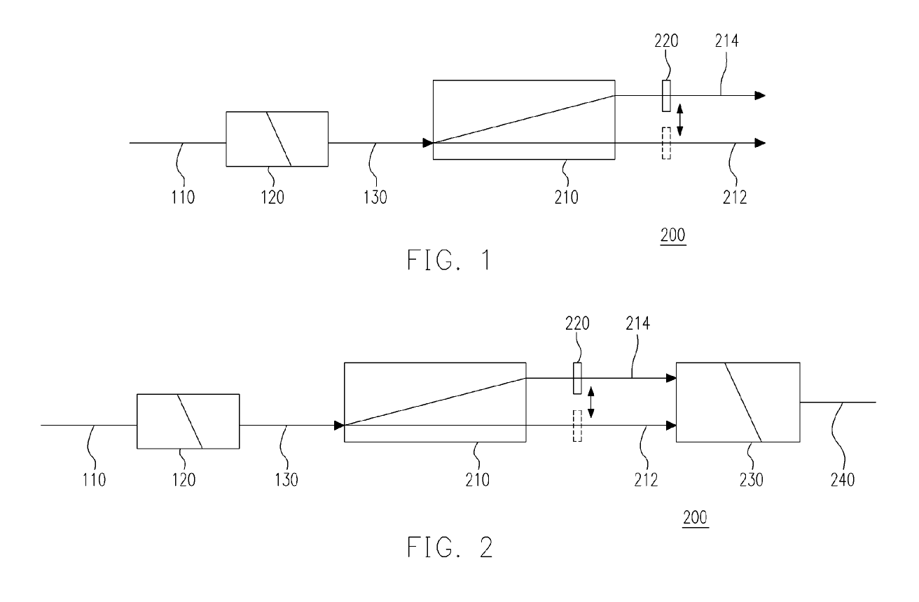

FIG. 2 is a drawing schematically illustrating an optical polarization controller according to one embodiment of the present invention. The embodiment shown in FIG. 2 is similar to that shown in FIG. 1, however, the optical polarization controller 200 of FIG. 2 further comprises a collimating device 230 and a polarization maintaining optical fiber 240. The collimating device 230 is disposed in the light path of the first light beam 212 and the second light beam 214 after the half-wave plate 220. The collimating device 230 comprises, for example but not limited to, an aspheric lens, a collimator or other lens for collimating. In addition, the polarization maintaining optical fiber 240 is connected after the collimating device 230.

Referring to FIG. 2, the first light beam 212 and the second light beam 214 are incident to the collimating device 230 respectively. Then, the first light beam 212 and the second light beam 214 are incident to the polarization maintaining optical fiber 240. Therefore, a TE polarized light beam or a TM polarized light beam may be provided to other optical device (not shown) by the polarization maintaining optical fiber 240. In comparison with the conventional technology, the optical polarization controller 200 of the present invention outputs a TE polarized light beam or a TM polarized light beam with more higher power. It is noted that, in the embodiments of FIG. 1 and FIG. 2, the phase of the second light beam 214 is retarded in comparison with the phase of the first light beam 212. Therefore, for an optical device, if the dispersion is important and effective, the embodiments of FIG. 1 and FIG. 2 are not suitable and applicable. Therefore, the present invention provide another embodiments for dispersion dependent optical device, and the embodiments will be described in detail hereinafter.

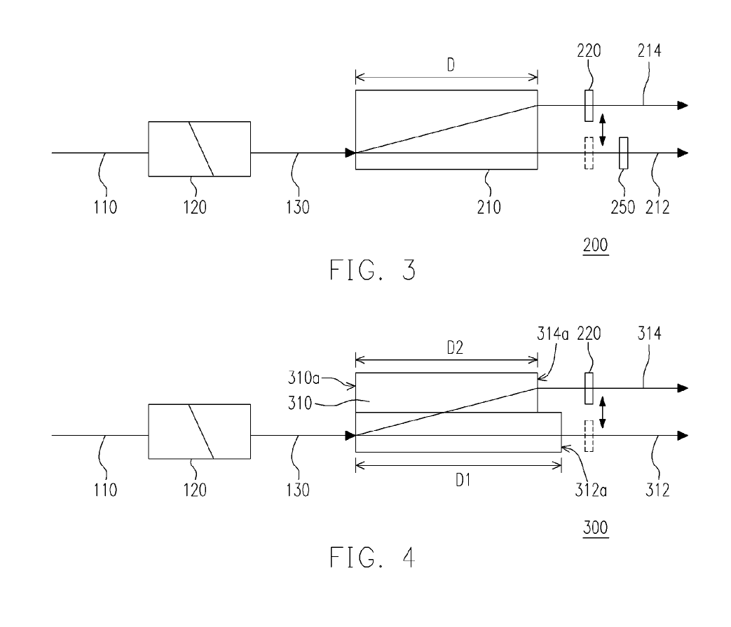

FIG. 3 is a drawing schematically illustrating an optical polarization controller according to one embodiment of the present invention. The embodiment shown in FIG. 3 is similar to that shown in FIG. 1, however, the optical polarization controller 200 of FIG. 3 further comprises a phase compensating crystal 250 disposed in the light path 212 of the first light beam. Therefore, the phase of the first light beam 212 and that of the second light beam 214 may be matched. In addition, the wavelength of the input light beam 130, the length D of the polarization splitting device 210 and the reflective index of the polarization splitting device 210 are dependent on the phase compensating crystal 250. In addition, as shown in FIG. 2, a collimating device (not shown) and a polarization maintaining optical fiber (not shown) connected after the collimating device may be provided in one embodiment of the invention. Therefore, a first light beam 212 and a second light beam 214 having the same phase may be provided to other optical device.

Accordingly, the optical polarization controller 200 of the present invention outputs TE polarized light beam or TM polarized light beam according to the user requirement. In addition, the optical polarization controller 200 of the present invention may further correct the dispersion of the TE polarized light beam or the TM polarized light beam. Moreover, in the invention, the device for matching the phase of the first light beam 212 and the phase of the second light beam 214 is not limited to the phase compensating crystal 250. A variety of embodiments will be described in detail hereinafter.

FIG. 4 is a drawing schematically illustrating an optical polarization controller according to one embodiment of the present invention. The embodiment shown in FIG. 4 is similar to that shown in FIG. 3, however, the phase of the first light beam 312 and the phase of the second light beam 314 outputted by the polarization splitting device 310 of the optical polarization controller 300 are the same. The polarization splitting device 310 comprises, for example but not limited to, a light incidence plane 310a, a first exit plane of light beam 312a and a second exit plane of light beam 314a. The distance D1 between the light incidence plane 310a and the first exit plane of light beam 312a is larger than the distance D2 between the light incidence plane 310a and the second exit plane of light beam 314a. Therefore, the first light beam 312 and the second light beam 314 outputted by the polarization splitting device 310 have the same phase.

Referring to FIG. 4, the difference between the distance D1 and D2 is dependent on the wavelength of the input light beam 130, the length D1 of the polarization splitting device 210, and polarization splitting device 310. In addition, as shown in FIG. 2, in one embodiment of the invention, a collimating device (not shown) and a polarization maintaining optical fiber (not shown) connected after the collimating device may also be provided.

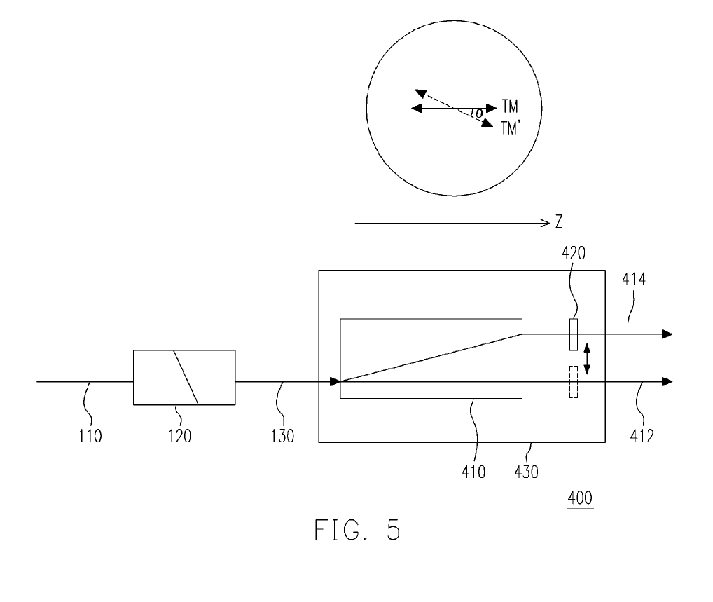

FIG. 5 is a drawing schematically illustrating an optical polarization controller according to one embodiment of the present invention. Referring to FIG. 5, the optical polarization controller 400 comprises, for example but not limited to, a polarization splitting device 410, a half-wave plate 420 and a rotation mechanism 430. The polarization splitting device 410 is provided for receiving the input light beam 130 and outputting a first light beam 412 and a second light beam 414. In addition, the half-wave plate 420 is switchably disposed in the light path of the first light beam 412 or the second light beam 414. Moreover, the polarization splitting device 410 and the half-wave plate 420 are mounted on the rotation mechanism 430. The rotation axis of the rotation mechanism 430 (for example but not limited to, the light path of the input light beam 130) are parallel to the propagation direction of the first light beam 412 and the second light beam 414 such as the direction Z shown in FIG. 5.

Referring to FIG. 5, for a planar lightwave circuit (PLC) device, the polarization direction of the polarized light beam inputted is dependent on the requirement of the device. Therefore, in the optical polarization controller of the present invention, the polarization direction of the first light beam 412 and the second light beam 414 may be changed by rotating the rotation mechanism 430. For example, referring to the circular region of FIG. 5, when a TM polarized light beam has to be outputted, and the polarization direction of the TM polarization light beam outputted by the optical polarization controller 400 is TM. And, the polarization direction of the TM polarized light beam required by the PLC device is TM′, wherein the angle between TM′ and TM is θ. Thus, the rotation mechanism 430 is rotated by an angle θ, and then the polarization direction TM of the TM polarized light beam outputted by the optical polarization controller is identical to the polarization direction TM′ of the TM polarization light beam of the PLC device.

Accordingly, the present embodiment are not only suitable for PLC device, however, the invention may also be provided for an optical device requiring a specific or limited polarization direction of TM polarized light beam or TE polarized light beam. It is noted that, for a dispersion sensitive optical device, there is a phase different between the first light beam 412 and the second light beam 414 of the embodiment shown in FIG. 5. Therefore, in one embodiment of the invention, the phase retardation crystal 250 (for example, shown in FIG. 3) or the polarization splitting device 310 (for example, shown in FIG. 4) may be incorporated with the embodiment shown in FIG. 5. Thus, a first light beam 412 and a second light beam 414 with the same phase may be provided.

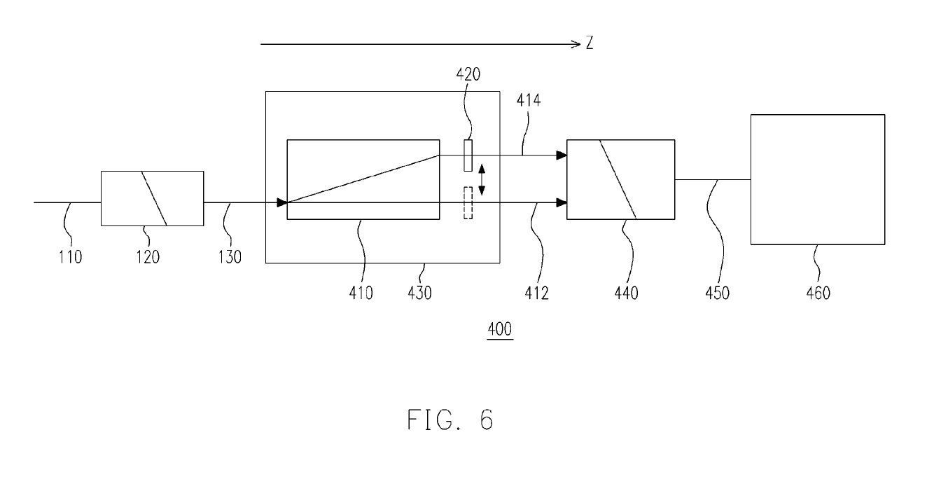

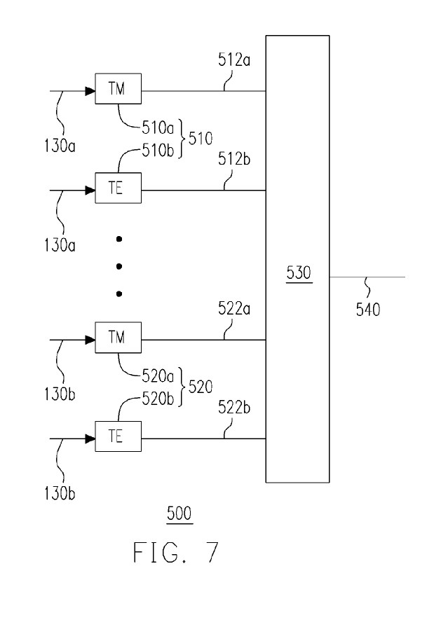

FIG. 6 is a drawing schematically illustrating an optical polarization controller according to one embodiment of the present invention. The embodiment shown in FIG. 6 is similar to that shown in FIG. 5, however, the optical polarization controller 400 of FIG. 6 further comprises a collimating device 440, a polarization maintaining optical fiber 450 and a planar waveguide chip 460. The collimating device 440 is disposed in the light path of the first light beam 412 and the second light beam 414 after the half-wave plate 420. In addition, the polarization maintaining optical fiber 450 is connected after the collimating device 440. Moreover, the planar waveguide chip 460 is connected to the polarization maintaining optical fiber 450.

Referring to FIG. 6, the polarization direction of the TM polarized light beam or the TE polarized light beam is limited by the planar waveguide chip 460. Therefore, the polarization direction of the first light beam 412 and the second light beam 414 are adjusted by the rotation mechanism 430 and may be identical to the polarization direction required by the planar waveguide chip 460. Then, the first light beam 412 and the second light beam 414 are incident to the collimating device 440. The collimating device 440 is provided for making the first and the second light beam to be mutually parallel. In addition, when the first light beam 412 and the second light beam 414 are propagated in the polarization maintaining optical fiber 450, the polarization direction of the first light beam 412 and the second light beam 414 can be maintained by the polarization maintaining optical fiber 450.

Accordingly, the polarization maintaining optical fiber 450 of the present embodiment is not limited to be connected to planar waveguide chip 460, but may also be connected to an optical device requiring specific or limited polarization direction of input light beam. As the embodiments shown in FIG. 5, there are a phase different between the first light beam 412 and the second light beam 414 outputted by the embodiment shown in FIG. 6. Therefore, in one embodiment of the invention, the phase retardation crystal 250 (for example, shown in FIG. 3) or the polarization splitting device 310 (for example, shown in FIG. 4) may be incorporated with the embodiment shown in FIG. 6. Thus, a first light beam 412 and a second light beam 414 with the same phase may be provided.

FIG. 7 is a drawing schematically illustrating an optical add multiplexer (OADM) used for the optical polarization controller of the present invention. Referring to FIG. 7, an optical add multiplexer (OADM) 500 is provided for receiving a plurality of input light beams having different wavelengths such as input light beams 130a and 130b, and for outputting a multi-wavelength light beam. The optical add multiplexer (OADM) 500 comprises, for example but not limited to, a plurality of optical polarization controller sets such as the optical polarization controller sets 510 and 520, a multiplexer 530 and a second polarization maintaining optical fiber 540. In one embodiment of the invention, the optical polarization controller sets 510 and 520 are, for example, provided for receiving the input light beams 130a and 130b with different wavelengths respectively, and for outputting a TM polarized light beam and a TE polarized light beam. The optical polarization controller sets 510 and 520 comprise, for example but not limited to, first optical polarization controllers 510a and 520a, second optical polarization controllers 510b and 520b, and first polarization maintaining optical fibers 512a, 512b, 522a and 522b. In addition, the multiplexer 530 is connected to the first and second optical polarization controllers 510a and 510b of the optical polarization controller set 510 by the first polarization maintaining optical fibers 512a and 512b respectively. The multiplexer 530 is also connect to the first and the second optical polarization controllers 520a and 520b of the optical polarization controller set 520 by the first polarization maintaining optical fibers 522a and 522b respectively. Moreover, the second polarization maintaining optical fiber 540 is connect to the multiplexer 530.

In the conventional technology, the light beam for data transmission includes a polarized input light beam 130a and another polarized input light beam 130b with different wavelengths. In other words, two wave channels are provided for data transmission in the conventional technology. However, in the invention, the optical add multiplexer (OADM) 500 provides a first optical polarization controller 510a and a second optical polarization controller 510b to split the input light beam 130a into a TE polarized light beam and a TM polarized light beam. Therefore, the TE polarized light beam and the TM polarized light beam may carry two different data. Thus, for a single wave channel, the data transmission of the invention is two times of that of the conventional technology. For example, if 8 wave channels in a range of 1560.61 nm (ITU21) to 1554.94 nm (ITU28) are provided, the conventional technology may use only 8 channels. However, the optical add multiplexer (OADM) 500 of the invention may split the light beam in each channel into a TE polarized light beam and a TM polarized light beam by the optical polarization controller. Therefore, in the invention, there are 16 wave channels may be used.

It is noted that, in one embodiment of the invention, the optical polarization controller of the embodiments shown in FIG. 3, FIG. 4 and FIG. 5 may also be applied in the optical add multiplexer (OADM) 500 shown in FIG. 5.

Accordingly, the optical polarization controller of the present invention has the advantages described above. First, in comparison with the conventional technology, the optical polarization controller of the present invention outputs a TE or a TM polarized light beam. In addition, the light intensity of the polarized light beam outputted by the optical polarization controller is approximate to that of the inputted single wavelength light beam. In addition, the optical polarization controller may correct the dispersion of the outputted TE or TM polarized light beam by using a phase retardation crystal or other polarization splitting device.

Next, the optical polarization controller of the present invention could change the polarization direction of the outputted TE or TM polarized light beam by a rotation mechanism. Therefore, the invention may be provided for an optical device requiring a specific or limited polarization direction. In addition, for dispersion sensitive optical device, the optical polarization controller of the present invention may correct the dispersion of the outputted TE or TM polarized light beam by a phase retardation crystal or a polarization splitting device.

Moreover, in comparison with the conventional technology, the optical polarization controller using the optical add multiplexer (OADM) of the present invention splits each light beam for data transmission into a TE and TM polarized light beam. Therefore, the data transmission of the optical polarization controller using the optical add multiplexer (OADM) of the present invention is two times of that of the conventional technology.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An optical polarization controller, for receiving an input light beam and outputting a transverse magnetic (TM) polarized light beam or a transverse electric (TE) polarized light beam, comprising:
a polarization splitting device, for receiving the input light beam and outputting a first light beam and a second light beam; and
a half-wave plate, switchably disposed in a light path of the first light beam or the second light beam.

2. The optical polarization controller of claim 1, further comprising:
a phase compensating crystal, disposed in the light path of the first light beam.

3. The optical polarization controller of claim 1, wherein the polarization splitting device further comprises:
a light incidence plane;
a first exit plane of light beam; and
a second exit plane of light beam, wherein a distance between the light incidence plane and the first exit plane of light beam is larger than a distance between the light incidence plane and the second exit plane of light beam, so that a phase of the first light beam and a phase of the second light beam are the same.

4. The optical polarization controller of claim 1, further comprising:
a collimating device, disposed in the light path of the first light beam and the light path of the second light beam after the half-wave plate.

5. The optical polarization controller of claim 4, further comprising:
a polarization maintaining optical fiber, connected after the collimating device.

6. An optical polarization controller, for receiving an input light beam and outputting a transverse magnetic (TM) polarized light beam or a transverse electric (TE) polarized light beam, comprising:
a polarization splitting device, for receiving the input light beam and outputting a first light beam and a second light beam;
a half-wave plate, switchably disposed in a light path of the first light beam or the second light beam; and
a rotation mechanism, for loading the polarization splitting device and the half-wave plate, wherein a rotation axis of the rotation mechanism is parallel to a propagation direction of the first light beam and the second light beam.

7. The optical polarization controller of claim 6, further comprising:
a phase compensating crystal, disposed on the rotation mechanism and in the light path of the first light beam.

8. The optical polarization controller of claim 6, wherein the polarization splitting device further comprises:
a light incidence plane;
a first exit plane of light beam; and
a second exit plane of light beam, wherein a distance between the light incidence plane and the first exit plane of light beam is larger than a distance between the light incidence plane and the second exit plane of light beam, so that a phase of the first light beam and a phase of the second light beam are the same.

9. The optical polarization controller of claim 6, further comprising:
a collimating device, disposed in the light path of the first light beam and the second light beam after the half-wave plate.

10. The optical polarization controller of claim 9, further comprising:
a polarization maintaining optical fiber, connected after the collimating device.

11. The optical polarization controller of claim 10, further comprising:
a planar waveguide chip, connected to the polarization maintaining optical fiber.
